(19) United States
(12) Patent Application Publication
(10) Pub. No.: US 2017/0082437 A1
(43) Pub. Date: Mar. 23, 2017

(54) PLUMB BOB ASSEMBLY FOR HYRAULIC HAMMER

(71) Applicant: Caterpillar Inc., Peoria, IL (US)

(72) Inventors: Dimitar Dostinov, Fort Worth, TX (US); Stephen P. Amborski, China Spring, TX (US); Francis E. Fortner, Woodway, TX (US); Bradley K. Hamrick, Moody, TX (US)

(73) Assignee: Caterpillar Inc., Peoria, IL (US)

(21) Appl. No.: 14/859,972

(22) Filed: Sep. 21, 2015

(51) Int. Cl. G01C 15/10; B25D 9/00

(52) U.S. Cl. CPC G01C 15/10; B25D 9/00; B25D 2250/161

(57) ABSTRACT

A plumb bob assembly includes a vertical bar that includes an upper end and a lower end. The plumb bob assembly further includes a plumb bob coupled to the lower end of the vertical bar. The plumb bob assembly further includes a cross plate coupled to the vertical bar. The cross plate is located near the upper end and extends perpendicularly across the vertical bar. The cross plate includes a front end and a back end. The plumb bob assembly also includes a pair of horizontal reference plates. Each horizontal reference plate includes a reference end, each of the reference ends are configured to align with the front end or the back end of the cross plate.

### TECHNICAL FIELD

The present disclosure relates to a hydraulic hammer, and more particularly relates to a plumb bob assembly to maintain the hydraulic hammer in a vertical position.

### BACKGROUND

Hydraulic hammers are widely used on work sites to break up or demolish large hard objects, such as, rocks, concrete, asphalt, frozen ground, etc., before such objects can be moved away. Hydraulic hammers can be mounted to work machines like back hoes or excavators, or they can be hand-held. During operation, high pressure fluid drives a piston of the hydraulic hammer to strike a work tool, such as a tool bit, this strikes the hard object to break. Generally, the work tool is configured to break rocks and penetrate ground surfaces. Consequently, because of repeated impact of the work tool on hard objects, the hydraulic hammer experiences extreme loads during operation. Such extreme loads often cause change in position of the hydraulic hammer during machine operations.

U.S. Pat. No. 3,383,946 discloses the making of large bore holes on the order, for example, of 48 inches to 72 inches in diameter for use in atomic bomb tests, vertical mine shafts, access bores and ventilation or escape shafts for mines, it is necessary to employ in the drilling procedure an enormous amount of drilling weight for use with the large drilling bit. The drill collar may weigh between 200,000 to 300,000 pounds and its diameter may be nominally 60 inches when employing a bit 72 inches in diameter. A drilling rig conventionally can accommodate only three drill collars connected end to end for a distance of 90 feet but the conventional collars thus connected would not provide the necessary weight for drilling large bore holes.

### SUMMARY OF THE DISCLOSURE

In one aspect of the present disclosure, a plumb bob assembly is provided. The plumb bob assembly includes a vertical bar including an upper end and a lower end. The plumb bob assembly further includes a plumb bob coupled to the lower end of the vertical bar. The plumb bob assembly further includes a cross plate coupled to the vertical bar. The cross plate is located near the upper end and extends perpendicularly across the vertical bar. The cross plate includes a front end and a back end. The plumb bob assembly further includes a first horizontal reference plate including a reference end configured to align with the front end or the back end of the cross plate.

In another aspect of the present disclosure, a hydraulic hammer system is provided. The hydraulic hammer system includes a housing including a distal face, a proximal face and a pair of side faces. The housing defining a chamber therein. The hydraulic hammer system further includes a work tool positioned in the chamber. The hydraulic hammer system further includes a plumb bob assembly located on the housing. The plumb bob assembly is configured to maintain the hydraulic hammer in a vertical position. The plumb bob assembly includes a vertical bar including an upper end and a lower end. The plumb bob assembly further includes a plumb bob coupled to the lower end of the vertical bar. The plumb bob assembly further includes a cross plate coupled to the vertical bar. The cross plate is located near the upper end and extends perpendicularly across the vertical bar. The cross plate includes a front end and a back end. The plumb bob assembly further includes a first horizontal reference plate including a reference end configured to align with the front end or the back end of the cross plate.

Other features and aspects of this disclosure will be apparent from the following description and the accompanying drawings.

### BRIEF DESCRIPTION OF THE DRAWINGS

FIG. 1 illustrates a side view of a machine having an implement system according to an embodiment of the present disclosure;

FIG. 2 illustrates a perspective view of the hydraulic hammer system according to an embodiment of the present disclosure;

FIG. 3 illustrates a view from an operator's end of the plumb bob assembly of the hydraulic hammer system according to an embodiment of the present disclosure;

FIG. 4 illustrates a view from the operator's end of the plumb bob assembly of the hydraulic hammer system according to an embodiment of the present disclosure; and

FIG. 5 illustrates a side view of the plumb bob assembly of the hydraulic hammer system according to an embodiment of the present disclosure.

### DETAILED DESCRIPTION

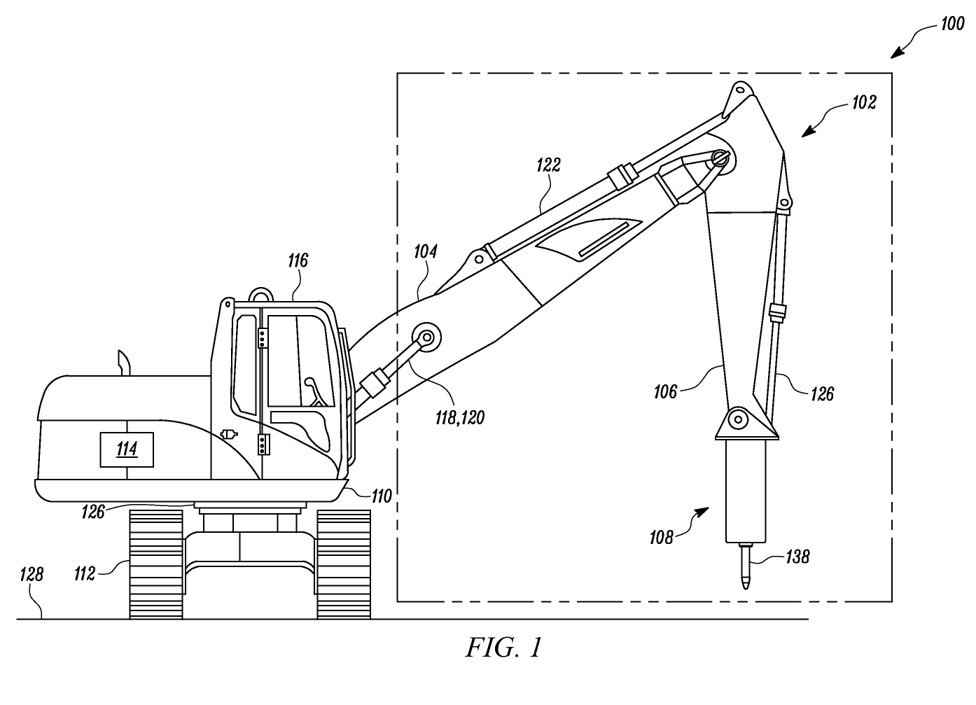

FIG. 1 illustrates a side view of a machine 100 having an implement system 102 according to an embodiment of the present disclosure. The machine 100 may include, but is not limited to, an excavator, a material handler, a long reach excavator, a foundation drill, a rock drill, a piling machine, a tunneling machine, and a front shovel. In the illustrated embodiment, the machine 100 may be shown as an excavator-type earthmoving or logging machine and the implement system 102, includes linkages such as a boom 104, a stick 106, and a hydraulic hammer system 108. The boom 104 may be pivotally connected to a chassis 110 of the machine 100, the stick 106 may be pivotally connected to the boom 104, and the hydraulic hammer system 108 may be pivotally connected to the stick 106.

The machine 100 may also include a drive system 112, such as tracks for propelling the machine 100, a power source 114 to power the implement system 102 and the drive system 112, and an operator cab 116 for hosting user interface devices for controlling the implement system 102 and the drive system 112. The power source 114 may embody an engine, such as a diesel engine, a gasoline engine, a gaseous fuel-powered engine or any other type of combustion engine known in the art. The power source 114 may alternatively embody a non-combustion source of power such as a fuel cell, a power storage device, or another source known in the art. The power source 114 may produce a mechanical or electrical power output that may then be converted to hydraulic power for moving the implement system 102.

The boom 104 may be raised and lowered by a pair of first hydraulic actuators 118, 120. The stick 106 may be moved toward and outward with respect to the operator cab 116 by a second hydraulic actuator 122. A third hydraulic actuator 124 may be used to operate the hydraulic hammer system 108 relative to the stick 106. Moreover, the chassis 110, and the implement system 102 it carries, may be rotated about a vertical-axis by a fourth hydraulic actuator 126, such as a hydraulic motor (not shown), with respect to the drive system 112 along a ground surface 128. In the illustrated embodiment of FIG. 1, the machine 100 is embodied in the form of a tracked industrial vehicle such as an excavator, wherein the hydraulic hammer system 108 is mounted to replace an excavator bucket (not shown) previously associated with the excavator. Consequently, the hydraulic hammer system 108 may be beneficially operated by the excavator's hydraulics.

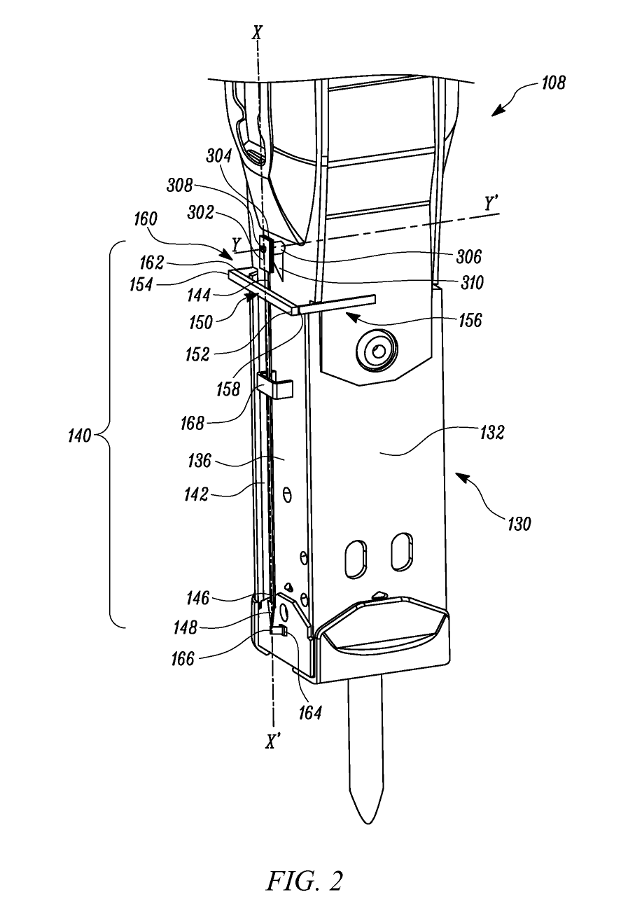

FIG. 2 illustrates a perspective view of the hydraulic hammer system 108 according to an embodiment of the present disclosure. The hydraulic hammer system 108 may include a housing 130. The housing 130 may include a proximal face 132, a distal face 134 and a pair of side faces 136. The hydraulic hammer system 108 may further include a work tool 138 (shown in FIG. 1) positioned in the chamber. The work tool 138 may be configured to break rocks and penetrate ground surfaces. The hydraulic hammer system 108 may further include a plumb bob assembly 140 located on the housing 130 disposed at one of the pair of side faces 136. The plumb bob assembly 140 may be configured to maintain the hydraulic hammer system 108 in a vertical position. The plumb bob assembly 140 may include a vertical bar 142 including an upper end 144 and a lower end 146. The vertical bar 142 may be defined along a longitudinal axis X-X′.

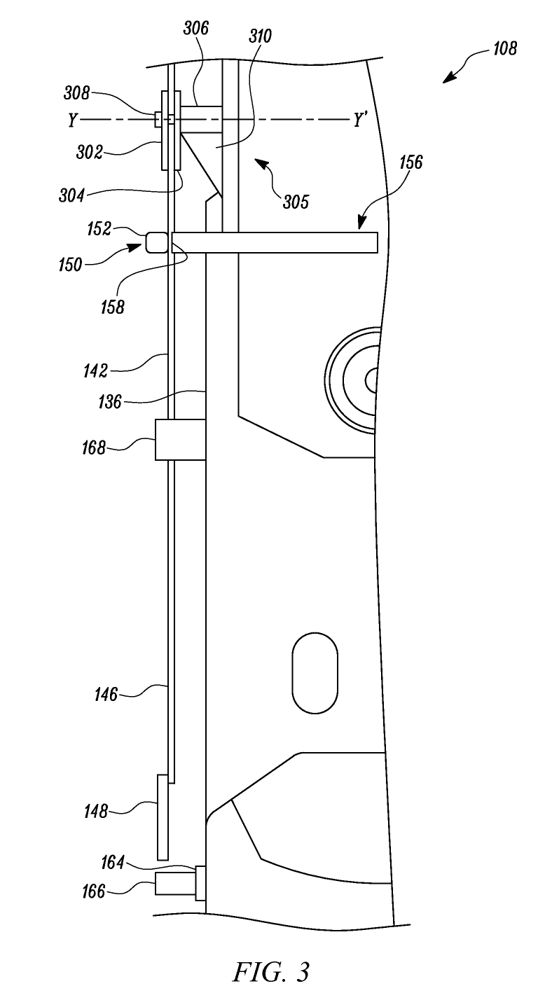

The plumb bob assembly 140 may further include a plumb bob 148 coupled to the lower end 146 of the vertical bar 142. The plumb bob assembly 140 may further include a cross plate 150 fixedly coupled to the vertical bar 142. In some embodiments, the cross plate 150 is welded to the vertical bar 142. The cross plate 150 may be located near the upper end 144 and may extend perpendicularly across the vertical bar 142. The cross plate 150 may further include a front end 152 and a back end 154. The front end 152 and the back end 154 of the cross plate 150 are located near the proximal face 132 and the distal face 134 respectively. The plumb bob assembly 140 may further include a first horizontal reference plate 156. The first horizontal reference plate 156 includes a first reference end 158 configured to align with the front end 152. The plumb bob assembly 140 may further include a second horizontal reference plate 160. The second horizontal reference plate 160 includes a second reference end 162 configured to align with the back end 154 of the cross plate 150. In an embodiment, there may be a gap of about 4 mm (shown in FIG. 3) between the first horizontal reference plate 156 or the second horizontal reference plate 160 and the cross plate 150.

The plumb bob assembly 140 may further include a side reference plate 164 that may be configured to align with the plumb bob 148. The side reference plate 164 may further include a pointer 166 to indicate a vertical angle X°. The plumb bob 148 may be in the shape of an arrowhead such that the arrow points downwards. Further, the front end 152, the back end 154, the first and second reference ends 158,162 and the plumb bob 148 may be colored to enhance visibility to an operator. The plumb bob assembly 140 may further include a restrictor plate 168 that may be configured to restrict a swinging motion of the vertical bar 142. In an embodiment, the restrictor plate 168 may be located on the side face 136 of the housing 130 that includes the plumb bob assembly 140. The restrictor plate 168 is placed between the plumb bob 148 and the cross plate 150 such that it encloses the vertical bar 142.

FIG. 3 illustrates a view from the proximal end, i.e., operator's end of the plum bob assembly 140 of the hydraulic hammer system 108 according to an embodiment of the present disclosure. The vertical bar 142 may be disposed between a first rectangular plate 302 and a second rectangular plate 304. The vertical bar 142 is fixedly coupled between the first and second rectangular plate 302, 304. It may be contemplated that the coupling between the vertical bar 142 and the first and second rectangular plates 302, 304 can be via, but not limited to, welding, riveting, or any other means known in the art. Further, each of the first and second rectangular plates 302, 304 include identical holes (not shown).

The plumb bob assembly 148 includes a coupling assembly 305. The coupling assembly 305 is configured to couple the vertical bar 142 via the first and second rectangular plates 302, 304. The coupling assembly 305 includes a boss member 306, a gusset member 310 and a fastening member 308. In an embodiment, the boss member 306 may be disposed on the hydraulic hammer system 108 that may have a hole member (not shown). In another embodiment, the boss member 306 may be an integral part of the hydraulic hammer system 108 that may have a hole member (not shown). In an embodiment the first and second rectangular plates 302, 304 are arranged such that identical holes align with the hole member of the boss member 306. The hole member of the boss member 306 may have internal threads to receive the fastening member 308. The fastening member 308 slidably engages within the identical holes of the rectangular plates 302, 304 and the hole member of the boss member 306. In an embodiment, the fastening member 308 is configured to fasten the upper end 144 of the vertical bar 142 with the boss member 306. The vertical bar 142 is pivotally coupled by the coupling assembly 305 such that the rectangular plates 302, 304 may rotate about a horizontal axis Y-Y′ through the boss member 306.

In the present embodiment, the gusset member 310 is connected to the boss member 306 and configured to maintain the boss member 306 perpendicular to the machine 100. The gusset member 310 may be welded to the hydraulic hammer system 108. The gusset member 310 may include thick sheets of steel that may be used to connect beams and girders to columns. Further, the gusset member 310 allows for the boss member 306 to be placed on a top surface (not shown) of the gusset member 310. In another embodiment, the gusset member 310 may be welded to the boss member 306.

Referring to FIG. 3, the hydraulic hammer system 108 is in a vertical position. The vertical bar 142 is parallel to the longitudinal axis X-X′. In such a condition, the first horizontal reference plate 156 and the second horizontal reference plate 160 align with the cross plate 150, in a single plane as shown, when viewed by the operator. Also, the front and back ends 152, 154 lie on the same plane. Accordingly, the operator may ascertain that the hydraulic hammer system 108 is substantially, if not exactly vertical with respect to the ground surface 128. During the operation of the hydraulic hammer system 108, the plumb bob assembly 140 remains vertical due to gravity. The vertical bar 142 aligns itself in the vertical orientation. Further, the front end 152 of the cross plate 150 aligns itself with the first and second horizontal reference plate 156, 160 in the same plane, as shown in FIG. 3. The plumb bob assembly 140 when observed from either of the sides of the hydraulic hammer system 108, the plumb bob 148 points towards the pointer 166 of the side reference plate 164, if the hydraulic hammer system 108 remains vertical.

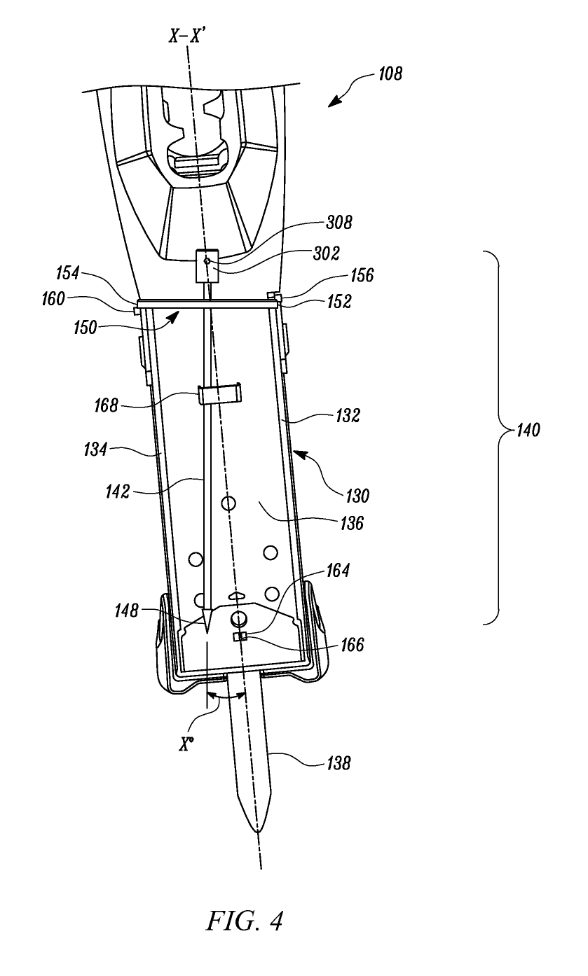

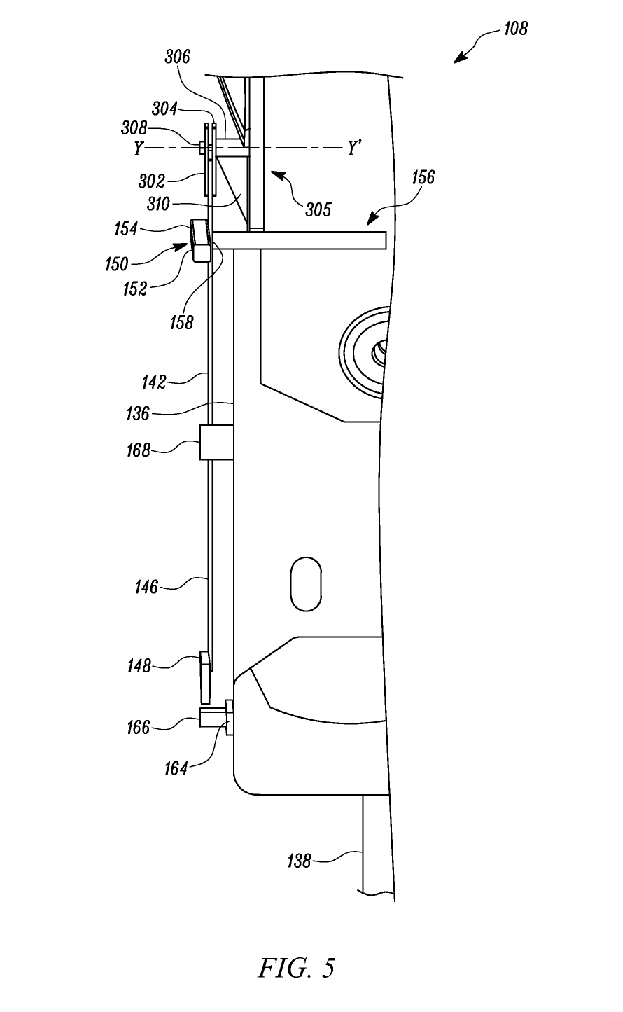

FIGS. 4 and 5 illustrate a view, according to an embodiment of the present disclosure, for example, when the hydraulic hammer system 108 is not vertical with respect to the ground surface 128. As shown in FIG. 4, during the operation of the machine 100, the hydraulic hammer system 108 displaces such that the work tool 138 moves towards the machine 100, i.e., towards the operator. The displacement will in turn, affect the vertical position of the plumb bob assembly 140. The vertical bar 142 aligns itself in a vertical position due to gravity. Further, the front end 152 of the cross plate 150 moves because of the position of the vertical bar 142, and in turn, is no longer aligned with the first reference end 158 (shown in FIG. 5) of the first horizontal reference plate 156, i.e., the front end 152 moves below the first reference end 158 when viewed by the operator. Simultaneously, the back end 154 moves away from the second reference end 162 (not shown), i.e., the back end 154 moves above the second reference end 162. Specifically, the operator will be able to detect the lack of alignment by observing, for example, the position of the first reference end 158 of the first horizontal reference plate 156, with respect to the front end 152 of the cross plate 150. Accordingly, the operator may ascertain that the hydraulic hammer system 108 is not vertical with respect to the ground surface 128.

In a certain condition another operator may be outside the operator cab 116, such that the second operator views the hydraulic hammer system 108 from one of the side faces 136. As shown in FIG. 4, the vertical bar 142 may be displaced from the longitudinal axis X-X′ by an angle X° to a certain angle, for example, 5 degrees. The second operator can see the plumb bob 148 moving away from the side reference plate 164, and in turn, away from the pointer 166 indicating a deflection in the vertical position of the hydraulic hammer system 108 with respect to the ground surface 128. The restrictor plate 168 may be configured to restrict a swinging motion of the vertical bar 142.

### INDUSTRIAL APPLICABILITY

The present disclosure relates to the plumb bob assembly 140 of the hydraulic hammer system 108 of the machine 100. The front end 152, the back end 154, the first and second reference ends 158,162 and the plum bob 148 are colored to enhance visibility to the operator for controlling the operation of the machine 100. In some embodiments, the front end 152, the back end 154, the first and second reference ends 158,162 and the plum bob 148 are painted with a colored paint or dye that enhances visibility at night time or under poor light conditions. The plumb bob assembly 140 ensures that the hydraulic hammer system 108 is kept in a vertical position. Also, with the use of the plumb bob assembly 140, the hydraulic hammer system 108 can be consistently maintained in a vertical position to prevent any premature failure.

The present embodiment is a plumb bob assembly 140 for keeping the hydraulic hammer system 108 in a vertical position. The hydraulic hammer system 108 mounts the vertical bar 142 on a side face 136 of the housing 130. The plumb bob 148 is coupled to the lower end 146 of the vertical bar 142. Further, the cross plate 150 is coupled near the upper end 144 of the vertical bar 142 that extends perpendicularly across the vertical bar 142. The cross plate 150 includes the front end 152 that may be located near the proximal face 132 of the housing 130 and the back end 154 that may be located near the distal face 134 of the housing 130.

In the present embodiment the first horizontal reference plate 156 is mounted on the proximal face 132 of the housing 130. The front end 152 of the cross plate 150 is aligned with the first reference end 158 on the first horizontal reference plate 156. Further, the second horizontal reference plate 160 is mounted on the distal face 134 of the housing 130. The back end 154 of the cross plate 150 is aligned with the second reference end 162 that is located on the second horizontal reference plate 160.

The front end 152, the back end 154, the reference ends 158,162 and the plumb bob 148 are colored to enhance visibility to the operator. The coloring aids the operator to visually check the alignment of the hydraulic hammer system 108 while operating the machine 100. The side reference plate 164 is mounted on one of the side faces 136 of the housing 130 that includes the plumb bob assembly 140. The plumb bob 148 is aligned with the side reference plate 164. The side reference plate 164 indicates deflection of the hydraulic hammer assembly 108 via deflection of the plumb bob 148 from the pointer 166. The housing 130 of the hydraulic hammer system 108 mounts the restrictor plate 168 on the side face 136 of the housing 130 between the plumb bob 148 and the cross plate 150. The restrictor plate 160 prevents the vertical bar 142 of the plumb bob assembly 140 from deflecting beyond a certain degree, for e.g., 4 degrees from the vertical. Further, the plumb bob assembly 140 can be attached on various tools or machineries which require vertical positioning or alignment for operation for e.g., drills, breakers and the like.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A plumb bob assembly comprising:
a vertical bar comprising an upper end and a lower end;
a plumb bob coupled to the lower end of the vertical bar;
a cross plate coupled to the vertical bar, the cross plate located near the upper end and extending perpendicularly across the vertical bar, the cross plate comprising a front end and a back end; and
a first horizontal reference plate comprising a reference end configured to align with the front end or the back end of the cross plate.

2. The plumb bob assembly of claim 1 further comprising, a second horizontal reference plate comprising a reference end configured to align with the front end or the back end of the cross plate.

3. The plumb bob assembly of claim 1 further comprising, a side reference plate configured to align with the plumb bob.

4. The plumb bob assembly of claim 2, wherein the side reference plate comprises a pointer to indicate a vertical angle.

5. The plumb bob assembly of claim 1, wherein the plumb bob has an arrowhead shape.

6. The plumb bob assembly of claim 1, wherein the front end, the back end, the reference ends and the plum bob are configured to enhance visibility.

7. The plumb bob assembly of claim 1 further comprising, a restrictor plate configured to restrict a swinging motion of the vertical bar.

8. The plumb bob assembly of claim 1 further comprising, a coupling assembly configured to couple the plumb bob assembly to a machine operating in a vertical position.

9. The plumb bob assembly of claim 8, wherein the coupling assembly comprises:
a boss member fixedly coupled to the machine;
a gusset member connected to the boss member and configured to maintain the boss member perpendicular to the machine; and
a fastening member configured to fasten the upper end of the vertical bar to the boss member.

10. The plumb bob assembly of claim 8, wherein the machine is a hydraulic hammer.

11. A hydraulic hammer system comprising:
a housing comprising a distal face, a proximal face and a pair of side faces, the housing defining a chamber therein;
a work tool positioned in the chamber;
a plumb bob assembly located on the housing, the plumb bob assembly configured to maintain the hydraulic hammer in a vertical position, the plumb bob assembly comprising:
a vertical bar located on a side face of the housing, the vertical bar comprising an upper end and a lower end;
a plumb bob coupled to the lower end of the vertical bar;
a cross plate coupled to the vertical bar, the cross plate located near the upper end and extending perpendicularly across the vertical bar, the cross plate comprising a front end located near the proximal face and a back end located near the distal face; and
a first horizontal reference plate comprising a reference end configured to align with the front end or the back end of the cross plate.

12. The hydraulic hammer system of claim 11 further comprising, a second horizontal reference plate mounted on the proximal face or the distal face, the second horizontal reference plate comprising a reference end configured to align with the front end or the back end of the cross plate.

13. The hydraulic hammer system of claim 11 further comprising, a side reference plate located on the side face of the housing, the side reference plate configured to align with the plumb bob.

14. The hydraulic hammer system of claim 12, wherein the side reference plate comprises a pointer to indicate a vertical angle.

15. The hydraulic hammer system of claim 11, wherein the plumb bob has an arrowhead shape.

16. The hydraulic hammer system of claim 11, wherein the front end, the back end, the reference ends and the plum-bob are configured to enhance visibility.

17. The hydraulic hammer system of claim 11 further comprising, a restrictor plate located on the side face of the housing and placed between the plumb bob and the cross plate, the restrictor plate configured to restrict a swinging motion of the vertical bar.

18. The hydraulic hammer system of claim 11 further comprising, a coupling assembly configured to couple the plumb bob assembly to a side face of the housing.

19. The hydraulic hammer system of claim 18, wherein the coupling assembly comprises:
a boss member fixedly coupled to the side face of the housing;
a gusset member connected to the boss member and configured to maintain the boss member perpendicular to the side face of the housing; and
a fastening member configured to fasten the upper end of the vertical bar to the boss member.

20. The hydraulic hammer system of claim 18, wherein the coupling assembly is configured to allow a swinging motion of the vertical bar.
